(19) United States
(12) Patent Application Publication
(10) Pub. No.: US 2025/0203287 A1
(43) Pub. Date: Jun. 19, 2025

(54) AUDIO RENDERING SYSTEM FOR A VEHICLE

(71) Applicant: GM Global Technology Operations LLC, Detroit, MI (US)

(72) Inventors: Alaa M. Khamis, Courtice (CA); Ali Rafiei, Newmarket (CA); Luke John Popiel, Oxford, MI (US); Jarvis Chau, Markham (CA); Gaurav Talwar, Novi, MI (US)

(73) Assignee: GM Global Technology Operations LLC, Detroit, MI (US)

(21) Appl. No.: 18/541,061

(22) Filed: Dec. 15, 2023

(51) Int. Cl. H04R 3/12

(52) U.S. Cl. CPC H04R 3/12; H04R 2499/13

(57) ABSTRACT

An audio rendering system for a vehicle includes one or more vehicle speakers and a vehicle microphone for capturing one or more sounds. The audio rendering system also includes a vehicle processor for storing vehicle data including one or more of vehicle location, vehicle event data, and microphone data. The vehicle processor is configured to determine optimal audio settings for the vehicle based on one or more of the vehicle location, the vehicle event data, and the microphone data. Additionally, the vehicle processor is configured to apply the determined optimal audio settings to one or more vehicle speakers.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an audio rendering system for a vehicle.

Conventional vehicles include features that provide vehicle occupants with comfort and entertainment during use of the vehicle and while seated in a cabin of the vehicle. For example, vehicles typically include entertainment systems such as radios and other audio systems that may be used throughout the vehicle cabin to allow occupants to listen to music, podcasts, and other media.

While vehicle entertainment systems increase the enjoyment of vehicle occupants, such systems may be played at levels that obstruct other sounds from being heard by the vehicle occupants. For example, listening to music or other entertainment at a high volume may prevent occupants in the vehicle from hearing a siren of an emergency vehicle and, as such, may prevent the driver of the vehicle from properly operating the vehicle in response to the siren. Additionally, playing music at or above a certain decibel may violate noise ordinances at a particular time-of-day and/or near certain locations. Conventional vehicles lack the ability to detect external noise such as an oncoming emergency siren or to alert a vehicle occupant of a noise ordinance. As such, a need exists to allow vehicle occupants to enjoy entertainment systems while concurrently providing for proper operation of the vehicle.

### SUMMARY

In one configuration, an audio rendering system for a vehicle includes one or more vehicle speakers, a vehicle microphone for capturing one or more sounds, and a vehicle processor for storing vehicle data including one or more of vehicle location, vehicle event data, and microphone data. The vehicle processor is configured to determine optimal audio settings for the vehicle based on one or more of the vehicle location, the vehicle event data, and the microphone data. Additionally, the vehicle processor is configured to apply the determined optimal audio settings to one or more of the vehicle speakers.

The audio rendering system may include one or more of the following optional features. For example, the vehicle processor may be configured to adjust one or more of vehicle mode or vehicle audio settings based on the determined optimal audio settings. Further, the vehicle processor may be configured to adjust the vehicle audio settings by applying personalized and adaptive audio content and volume, individually controlling the one or more of the vehicle speakers for playback to create precise imaging for object audio using meta-data, adjusting gain for noise compliance, turning on or off commentary in a selected language, and/or adjusting the volume of crowd noise.

Additionally, the optimal audio settings may be based on mood information of an occupant of the vehicle. In some configurations, the microphone data includes any sound captured by the vehicle microphone. Additionally, the optimal audio settings may be determined using one or more of a contextual multi-armed bandit (MAB), epsilon-Greedy, Upper Confidence Bound (UCB), meta-learning Regularized Linear Bandit, or meta-learning Linear UCB. Additionally, the vehicle location may include one or more of Global Positioning System (GPS) location, route information, or places-of-interest in a vicinity of the vehicle. Moreover, in some configurations, a vehicle incorporates the audio rendering system.

In another configuration, an audio rendering system for a vehicle includes a vehicle microphone for capturing one or more sounds and a vehicle processor for storing vehicle data including one or more of vehicle location, vehicle event data, and microphone data. The vehicle processor is configured to determine if noise-reducing action is required based on the vehicle location and the microphone data. The vehicle processor is also configured to determine an optimal vehicle mode based on the vehicle event data and the vehicle location and activate the optimal vehicle mode of the vehicle.

The audio rendering system may include one or more of the following optional features. For example, the microphone data may include any sound captured by the vehicle microphone. Additionally, the optimal vehicle mode may be determined using one or more of a contextual multi-armed bandit (MAB), epsilon-Greedy, Upper Confidence Bound (UCB), meta-learning, Regularized Linear Bandit, or meta-learning Linear UCB learning strategies. In some configurations, the vehicle location may include one or more of GPS location, route information, or places-of-interest in a vicinity of the vehicle. Additionally, the vehicle processor may be configured to use third-party information such as a city or township noise ordinance to determine if the noise-reducing action is required. Moreover, a vehicle may incorporate the audio rendering system.

In yet another configuration, an audio rendering system for a vehicle includes a vehicle microphone for capturing one or more sounds and a vehicle processor for storing vehicle data including one or more of vehicle location, vehicle event data, and microphone data. The vehicle processor is configured to determine if a noise-reducing action should be implemented based on one or more of the vehicle's location and the microphone data. The vehicle processor is also configured to reduce a noise level within the vehicle based on the microphone data and the vehicle event data and to return the noise level back to the original noise level once it is determined that the noise-reducing action should no longer be implemented based on one or more of the vehicle location and the microphone data.

The audio rendering system may include one or more of the following optional features. For example, the noise-reducing action may include adjusting one or more of vehicle mode or vehicle audio settings. Additionally, the microphone data may include any sound captured by the vehicle microphone. In some configurations, the determination of if a noise-reducing action should be implemented may be determined using one or more of a contextual multi-armed bandit (MAB), epsilon-Greedy, Upper Confidence Bound (UCB), meta-learning, Regularized Linear Bandit, or meta-learning Linear UCB learning strategies. Additionally, the vehicle location may include one or more of GPS location, route information, or places-of-interest in a vicinity of the vehicle. In some configurations, the vehicle event data may include one or more of user settings, vehicle settings, and passenger information. Additionally, a vehicle may incorporate the audio rendering system.

### BRIEF DESCRIPTION OF THE DRAWINGS

The drawings described herein are for illustrative purposes only of selected configurations and are not intended to limit the scope of the present disclosure.

FIG. 1 is an exterior perspective view of a vehicle including an audio rendering system according to the present disclosure;

FIG. 2 is an interior perspective view of the vehicle of FIG. 1;

FIG. 3A is a functional block diagram according to one aspect of the audio rendering system of FIG. 1;

FIG. 3B is a functional block diagram according to another aspect of the audio rendering system of FIG. 1;

FIG. 4 is a functional block diagram according to yet another aspect of the audio rendering system of FIG. 1;

FIG. 5 is a functional block diagram according to yet another aspect of the audio rendering system of FIG. 1;

FIG. 6 is a functional block diagram according to yet another aspect of the audio rendering system of FIG. 1; and

FIG. 7 is an operational flow diagram according to one aspect of the audio rendering system of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

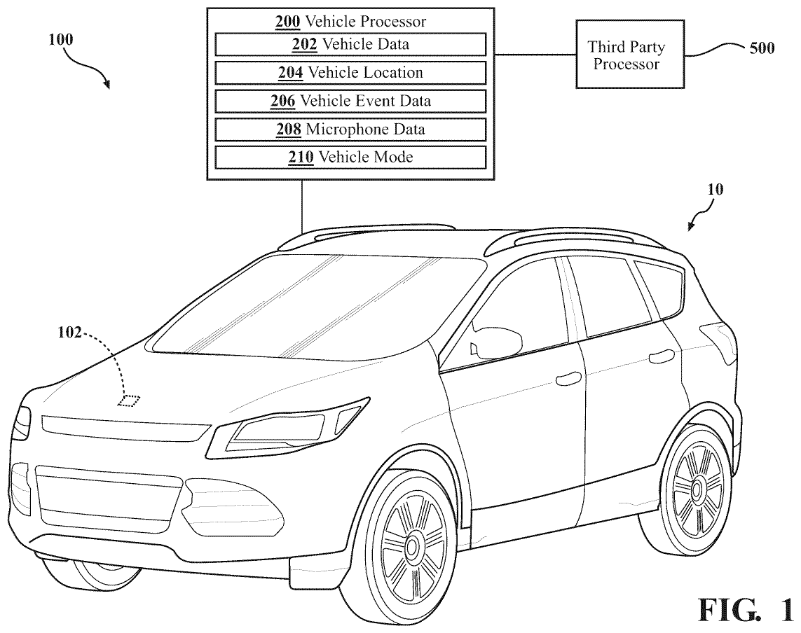

Referring to FIGS. 1-7, an audio rendering system 100 including a vehicle processor is disclosed. In FIG. 1, the audio rendering system 100 is incorporated into a vehicle 10. The vehicle 10 may include an internal combustion engine (ICE) and may include assisted or automated driving capabilities. Alternatively, the vehicle 10 may be an electric vehicle (EV) or may be a hybrid vehicle 10 incorporating both EV and ICE components and capabilities. Additionally, the vehicle 10 may include one or more vehicle microphones 102, one or more vehicle cameras 20, one or more vehicle sensors 22, and a vehicle interior 12 configured to allow one or more occupants therein and including a plurality of speakers 16.

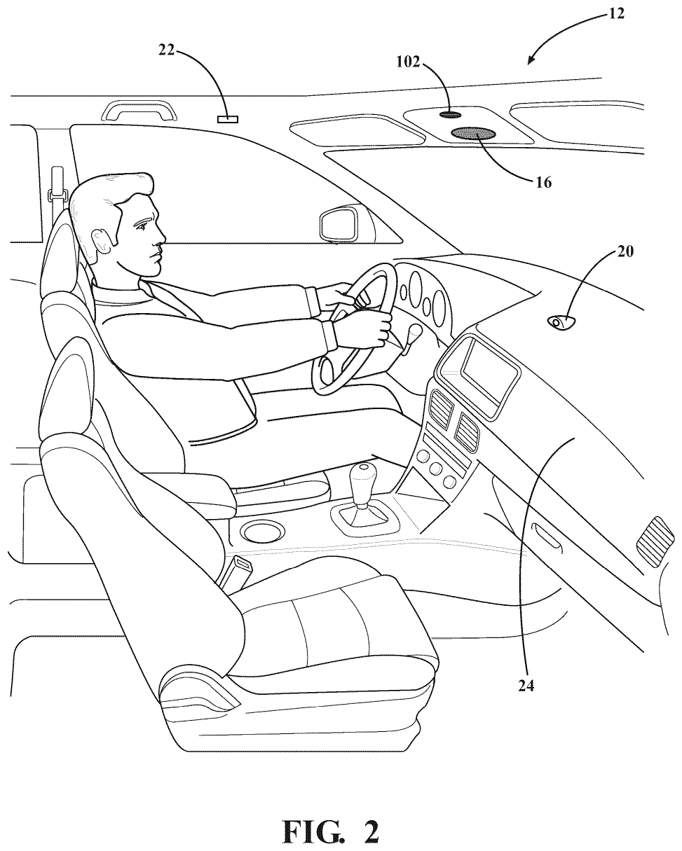

More specifically, referring to FIGS. 1 and 2, the vehicle 10 includes the vehicle microphone 102 that captures sounds in and around the vehicle 10. As shown in FIG. 1, the vehicle microphone 102 is in communication with the vehicle processor 200. The vehicle microphone 102 may include one or more vehicle microphones 102 disposed in the interior 12 and/or on an exterior of the vehicle 10. Additionally, the vehicle microphone 102 may be any type of microphone configured to transmit and/or record sound disposed in and around the vehicle 10. In some examples, the vehicle microphone 102 is a dynamic microphone, a condenser microphone, and/or a ribbon microphone. Additionally, the vehicle 10 may be equipped with one or more vehicle cameras 20 and/or vehicle sensors 22. The vehicle cameras 20 and/or sensors 22 may be disposed in the interior 12 and/or on an exterior of the vehicle 10 and are configured to provide data to the vehicle processor 200. Moreover, the vehicle interior 12 may also include one or more speakers 16 configured to project audio throughout the vehicle interior 12. The speakers 16 may be individually operated and controlled by the vehicle processor 200. Additionally, the vehicle interior 12 may include a vehicle dashboard 24 disposed within the interior 12, which may include an entertainment system having audio and/or visual capabilities. Further, the dashboard 24 may be configured to display words or images to the vehicle occupants via a display associated with the vehicle dashboard 24.

The audio rendering system 100 also includes the vehicle processor 200, which is configured to store vehicle data 202 of the vehicle 10. The vehicle data 202 includes one or more of vehicle location 204, vehicle event data 206, microphone data 208, and/or vehicle mode 210. The vehicle location 204 generally pertains to a location of the vehicle 10. The vehicle location 204 may be obtained from a Global Positioning System (GPS), other navigation system, and/or a third-party application or a third-party processor 500 in communication with the vehicle processor 200 (FIG. 1). Regardless of how the vehicle location 204 is obtained, this information may be communicated to and stored by the vehicle processor 200. Moreover, the vehicle location 204 may include route data such that a route the vehicle 10 is traveling, including origin and destination information, may also be communicated to the vehicle processor 200. Additionally, the vehicle location 204 may include contextual information such as places-of-interest in a vicinity of the vehicle and/or along the route of the vehicle. For example, the vehicle location 204 may include information that a hospital, retirement community, or a place of worship are along the route.

The vehicle event data 206 generally pertains to any data related to the vehicle 10. For example, the vehicle event data 206 may include vehicle speed, vehicle settings, or audio settings. The vehicle speed may include engine speed, desired engine speed, pedal inputs, and the like. The vehicle settings may also include any settings within the vehicle 10. For example, vehicle settings may include window settings or a sunroof setting. Additionally, the vehicle event data 206 includes audio settings including volume, language, audio standard type, commentary, or other settings for each of the speakers 16 in the vehicle interior 12.

The microphone data 208 generally pertains to any sounds that are detected by the vehicle microphone 102. The sounds may be produced by the vehicle 10 or may be any other sound detected by the vehicle microphone 102 either within the vehicle interior 12 or outside of the vehicle 10.

The vehicle mode 210 generally pertains to the current mode of operation of the vehicle 10. For example, the vehicle mode 210 may pertain to manually adjustable modes such as track mode, sport mode, or quiet mode. Additionally and/or alternatively, the vehicle mode 210 may include information related to how the vehicle 10 is currently being driven. For example, the vehicle mode 210 may include a mood of the vehicle occupant(s) including, but not limited to, the driver, with the mood of the occupant(s) including, but not limited to, stressed, drowsy, distracted, overwhelmed/fatigued, anxious, depressed, downhearted, and unmotivated. The driver's mood may affect how the driver is operating the vehicle 10, which may change a noise level of operation of the vehicle 10. For example, a stressed driver may more heavily press acceleration and brake pedals, thereby resulting in louder noises from the vehicle 10. In another example, a happy driver may enjoy a louder volume of music resulting in louder noises from the vehicle 10. The vehicle mode 210 may be gathered by prompting the driver or other occupant(s) to input the information or may be sensed and/or otherwise gathered through vehicle sensors 22 and/or cameras 20.

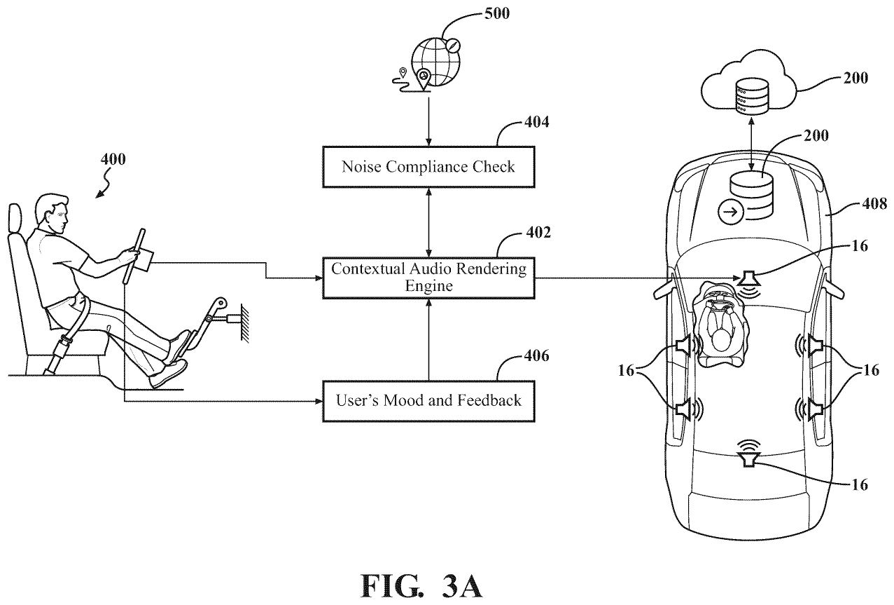

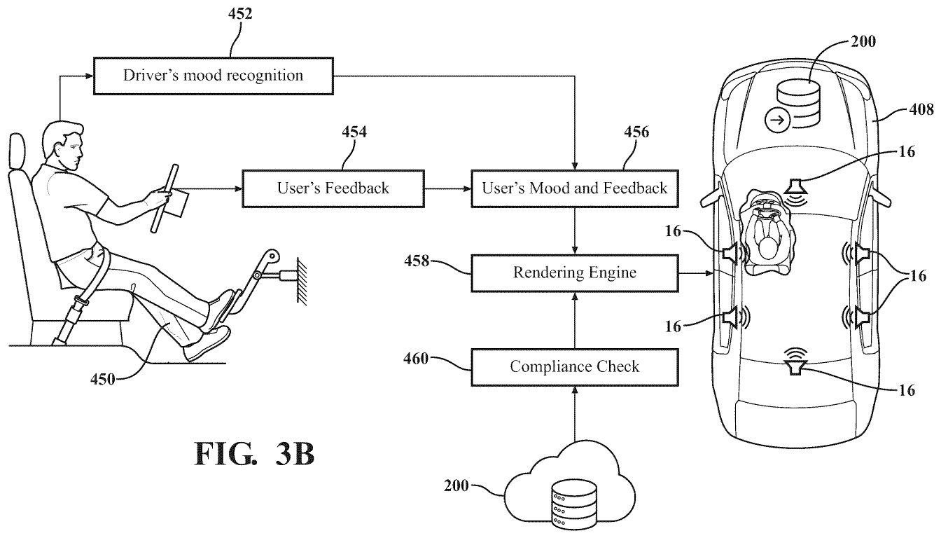

Referring still to the examples shown in FIGS. 1-7, the vehicle processor 200 may be configured as one or more of an in-vehicle controller, a network or a cloud-based system, or an edge system disposed closer to the vehicle 10 than a cloud-based system. For example, the vehicle processor 200 may include the in-vehicle controller, the cloud-based system, and the edge system working together as a single vehicle processor 200. In the example shown in FIGS. 3A and 3B, the vehicle processor 200 includes an in-vehicle controller and a cloud-based server working together as a single vehicle processor 200. The vehicle processor 200, including one or more of the in-vehicle controller, the edge controller, and the cloud-based server, may continuously and/or regularly update such that the vehicle data 202 is updated in real time.

Additionally, the vehicle processor 200 is configured to communicate with third-party processors 500 to collect third-party data. The third-party processors 500 may include, but are not limited to, vehicle processors along the route and/or third-party servers that may include government and municipality regulation databases, weather databases, or other third-party data related to compliance checks. For example, the vehicle processor of other vehicles along the route may transmit information related to oncoming sirens or other sounds. In other examples, the government and municipality regulation databases may include information related to noise regulations in cities or townships along the route that may be used to determine whether the vehicle 10 is in compliance with those regulations in a compliance check. Additionally, the third-party databases may include information related to hours of operation or other data related to places-of-interest along the route. Moreover, in some examples, the weather databases may include current, future, or past weather data along the route. Other third-party databases that may provide additional contextual information to the audio rendering system 100 may include date and time databases, sunrise and sunset data, and the like.

The vehicle processor 200 may also be configured to store and update a user profile for each vehicle occupant. The user profile may include preferences for each vehicle occupant such as preferred vehicle or audio settings. The user profile may also include other factors related to vehicle or audio settings such as age and/or hearing capabilities of the occupants.

Additionally, the vehicle processor 200 is configured to determine optimal audio settings for the vehicle 10 based on one or more of the vehicle location 204, the vehicle event data 206, the vehicle mode 210, and the microphone data 208. The optimal audio settings may be achieved by adjusting one or more of vehicle mode 210 or vehicle audio settings. For example, adjusting vehicle audio settings may include adjusting personalized and adaptive audio content and volume, individually addressing (i.e., selecting) speakers 16 for playback to create precise imaging for the object audio using metadata, adjusting gain for noise compliance, turning on/off commentary in a selected language, and/or adjusting the volume of crowd noise during a sporting event by applying a Moving Picture Experts Group—High Efficiency (MPEG-H) 3-dimensional audio standard and/or applying or denying noise compliance standards.

The optimal audio settings may be based on object-based audio including, but not limited to, Dolby Atmos®, MPEG-H, and Ambisonics®. The object-based audio is a format that treats each sound source as an independent object with its own metadata, such as location, volume, and direction. This allows the audio to be rendered dynamically according to the speaker layout, the listener's position, and the acoustic properties of the room. For example, if an occupant moves their head, the sound will adjust accordingly as object-based audio allows for a more flexible and personalized sound experience.

For example, as shown in FIG. 3A, the vehicle processor 200 may use vehicle data 202 including one or more of vehicle location 204, vehicle event data 206, and vehicle microphone data 208 as inputs at step 400 along with data from the third-party processor 500 related to the noise compliance regulations at step 404 and user feedback related to the vehicle mode 210 at step 406. The foregoing inputs may be supplied to a contextual audio rendering engine at step 402 to determine the optimal audio settings for the vehicle 10. The optimal audio settings may then be applied to the vehicle interior 12 at step 408. For example, the vehicle processor 200 may determine optimal audio settings include lowering audio output in a rear of the vehicle 10 if an infant or small child is located in a rear seat of the vehicle 10. Similarly, the vehicle processor 200 may determine optimal audio settings include increasing audio output to a higher volume if at least one window of the vehicle 10 is open or, conversely, may determine optimal audio settings include decreasing audio output to a lower volume if the vehicle 10 is pulling into a driveway in a residential neighborhood and/or it is late at night.

Additionally, as illustrated in FIG. 3B, the vehicle processor 200 may be configured to prompt the occupant to input mood information at step 454 and/or may use driver mood recognition techniques at step 452 to determine the driver mood at step 456. The driver mood information may also be entered into the contextual audio rendering engine at step 456. Additionally, the vehicle processor 200 may perform a compliance check at step 460 using information from the third-party processor 500, which is also entered into the contextual audio rendering engine. The optimal audio settings are then determined using the contextual audio rendering engine at step 458 and applied throughout the vehicle 10. For example, the vehicle processor 200 may store inputs related to a mood of the driver and input them into the contextual audio rendering engine to determine the optimal audio settings include raising the volume of an uplifting song when the driver's mood information indicates sadness.

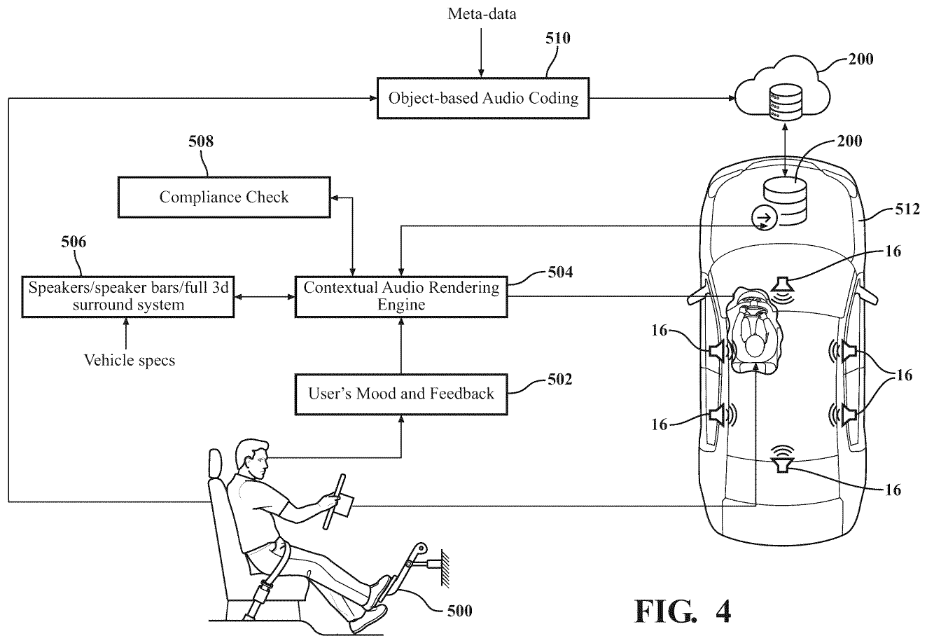

Referring now to the example shown in FIG. 4, the vehicle processor 200 may also be configured to use object-based audio coding to separate and determine a source of each sound gathered by the vehicle microphone(s) 102. Each sound is treated as an independent object with its own metadata, such as location, volume, and direction such that each object sound can be adjusted individually. For example, the vehicle data 202 and occupant mood and feedback are inputted into the contextual audio rendering engine at step 500 and 502. The vehicle settings including current audio settings are inputted at step 506 along with noise regulations for noise compliance checks at step 508. The object-based audio coding is performed at step 510 and sent to the vehicle processor 200. The optimal audio settings are then determined at step 504 using the contextual audio rendering engine before being applied to the vehicle interior 12 at step 512.

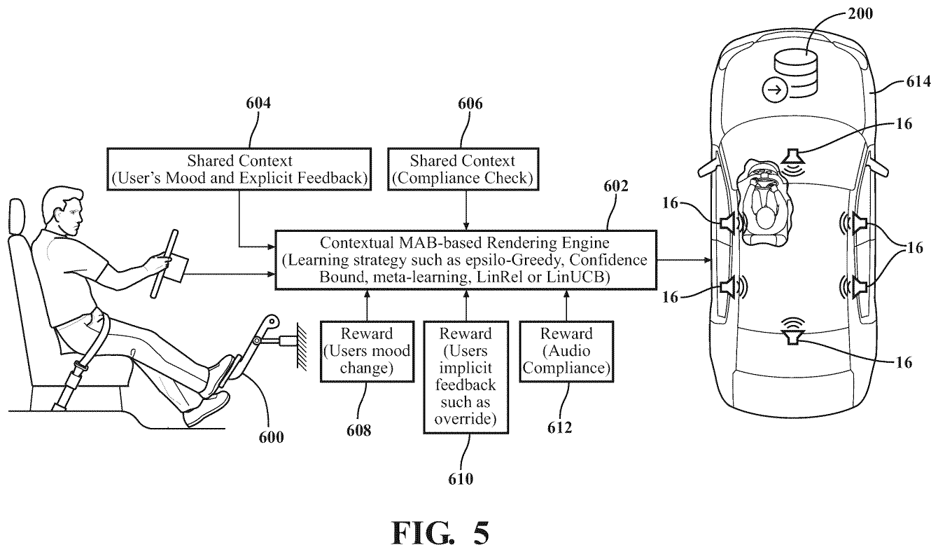

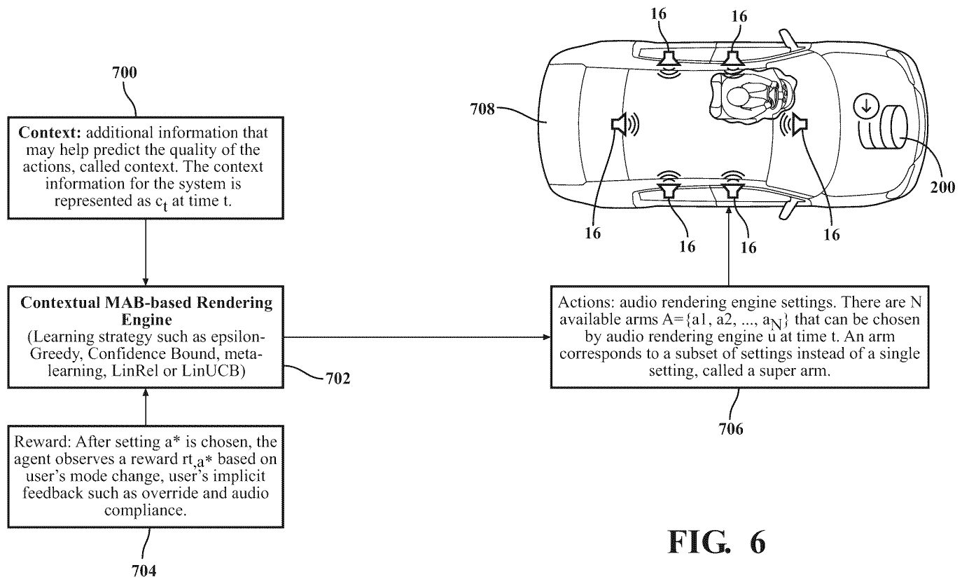

Referring now to the examples shown in FIGS. 5 and 6, the contextual audio rendering engine may include one or more of a contextual multi-armed bandit (MAB), epsilon-Greedy, Upper Confidence Bound (UCB), meta-learning, Regularized Linear Bandit, or meta-learning Linear UCB learning strategies. The examples shown in FIGS. 5 and 6 model a contextual MAB situation where, in a sequence of independent trials, the rendering engine automatically chooses, based on contextual information, an action from a set of possible actions so as to maximize the total payoff of the chosen actions. Further, in the example shown, the current mood of the occupant, explicit feedback, and noise compliance check are considered as shared contextual information. A reward is quantified based on occupants mood change, user's implicit feedback such as override, and audio compliance. This contextual information affects how a reward is associated with each action. For example, the contextual MAB may be developed by defining states/context and possible action space, defining reward function, training a neural network which intakes one-hot encoded states/context and outputs estimated rewards and/or penalties for each possible action and, finally, depending on the learned policy, choosing an action.

More specifically, in FIG. 5, the vehicle data 200 at step 600 along with occupant's mood and feedback at step 604 and compliance check information at 606 are inputted into the contextual rendering engine. Reward information, such as occupants mood change, user's implicit feedback such as override, and audio compliance information are also inputted into the contextual rendering engine at steps 608, 610, and 612. The optimal audio settings are then determined in the contextual rendering engine at step 602 and are applied to the vehicle 10. Similarly, in FIG. 6, contextual information is inputted into the contextual rendering engine at step 700 along with reward information at step 704. The contextual rendering engine determines if noise-reducing action is necessary at step 702 and further determines which noise-reducing action(s) should be taken at step 706.

Additionally and/or alternatively, a different strategy may be used to learn the optimal policy for rendering engine settings such as epsilon-Greedy, Upper Confidence Bound (UCB) or meta-learning, LinRel, and/or LinUCB. For example, LinUCB enables sequentially selecting audio rendering settings based on the contextual information and adjusts its setting selection strategy based on occupant explicit and implicit feedback.

The audio rendering system 100 may also use the contextual audio rendering engine or be otherwise configured to determine if noise-reducing action is required based on the vehicle location 204 and the microphone data 208. The vehicle processor 200 may use the microphone data 208 along with information from third-party processors 500 to determine if the current operation or estimated future operation of the vehicle 10 would be in compliance with the noise compliance information. If it is determined that the current operation or estimated future operation of the vehicle 10 exceeds the noise compliance information, the vehicle processor 200 may determine an optimal vehicle mode based on the vehicle event data 206 and the vehicle location 204 such that the vehicle 10 is in compliance with the noise regulations. For example, if the vehicle processor 200 determines that an engine of the vehicle 10 is creating noise that exceeds the noise regulations, the vehicle processor 200 may determine that the vehicle 10 should be moved to a regular drive mode from a sport mode to reduce engine noise. Once the vehicle processor 200 determines that the vehicle mode should be switched to comply with the noise regulations, the vehicle processor 200 may prompt the vehicle occupant to agree to the change in mode prior to activating the optimal vehicle mode of the vehicle 10. However, in some examples, the vehicle processor 200 may be configured to automatically change the vehicle mode without confirmation from the vehicle occupant.

Additionally or alternatively, if it is determined that the noise-reducing action should be implemented based on one or more of the vehicle location 204 and the microphone data 208, the noise-reducing action may include adjusting one or more vehicle audio settings. For example, the vehicle processor 200 may be configured to reduce a noise level within the vehicle interior 12 based on the microphone data 208 and the vehicle event data 206. More specifically, if a siren from an emergency vehicle is detected, the vehicle processor 200 may determine that the noise-reducing action of reducing the volume of the speakers 16 in the vehicle interior 12 should be implemented to allow the driver or other occupant(s) to hear the sirens and take action accordingly. Additionally, the vehicle processor 200 may be configured to return the noise level back to the original noise level once it is determined that the noise-reducing action should no longer be implemented based on one or more of the vehicle location 204 and the microphone data 208. For example, once the emergency vehicle having the siren has passed, the vehicle processor 200 may return the volume of the speakers 16 to the original volume.

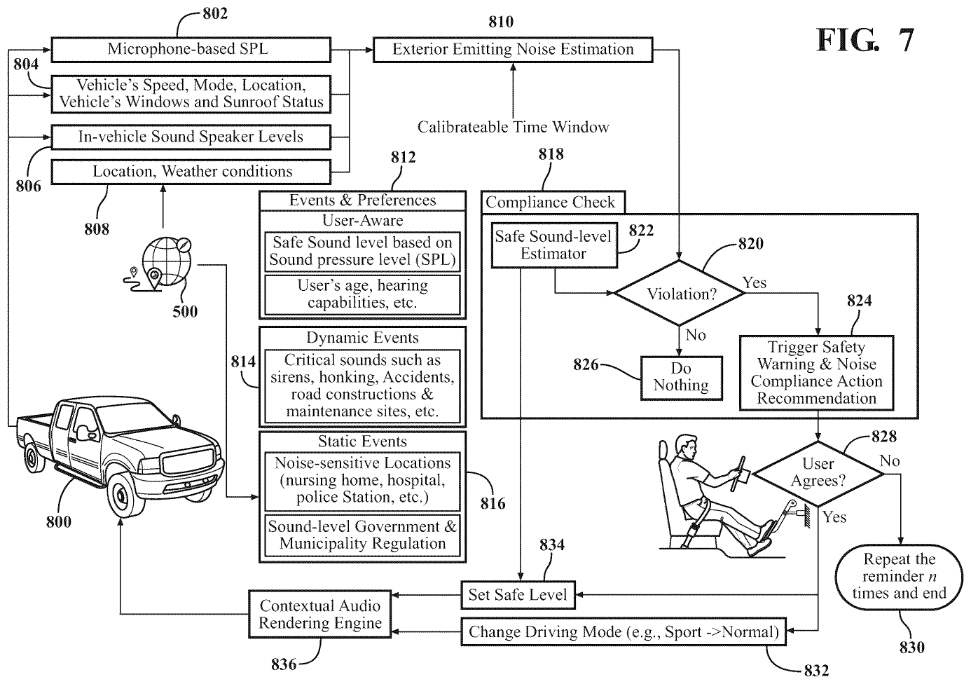

Referring now to the example shown in FIG. 7, in step 800 the vehicle 10 begins operation and inputs such as microphone data 208 at 802, vehicle event data 206 at 804, current audio levels at step 806, vehicle location 204, and weather information at 808 are inputted to a noise estimator at step 810. The noise estimator also includes data from the vehicle processor 200 or third-party processors 500. Further, the data includes the user profile at 812, dynamic events such as sirens, honking, accidents, or road construction if present at 814, and static events such as noise-sensitive locations and noise regulations at 816. The vehicle processor 200 estimates the noise and performs a compliance check at 818 to determine whether there is a noise violation at step 820. Additionally, the noise estimator is continually estimating based on continually updated data at step 822. If it is determined that there is not a noise violation, the vehicle processor 200 continues to monitor at step 826. However, if it is determined that the vehicle 10 is in violation, the vehicle processor 200 will determine adjustments to be in compliance with the noise regulations and suggests those adjustments to the occupant at step 824. If the occupant does not agree at step 828, the vehicle processor 200 may remind the occupant a predetermined number of times at step 830. However, if the occupant agrees at step 828, the vehicle processor 200 will change the vehicle mode at step 832 and set safe sound levels at step 834. The data will also be entered into the contextual audio rendering engine for further adjustment of the audio settings, if necessary at step 836.

The audio rendering system 100 as described herein provides for adjustment of audio and vehicle settings based on contextual information including dynamic and static events. These enhancements improve personalized experience and contribute to lessening vehicle noise emissions.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An audio rendering system for a vehicle, the audio rendering system comprising:
one or more vehicle speakers configured to produce sounds;
a vehicle microphone configured to capture one or more sounds;
a vehicle processor configured to store vehicle data including one or more of vehicle location, vehicle event data, vehicle mode, and microphone data and configured to:
determine optimal audio settings for the vehicle based on one or more of the vehicle location, the vehicle event data, and the microphone data; and
apply determined optimal audio settings to one or more of the vehicle speakers.

2. The audio rendering system of claim 1, wherein the vehicle processor is configured to adjust one or more of vehicle mode or vehicle audio settings based on the determined optimal audio settings.

3. The audio rendering system of claim 2, wherein the vehicle processor is configured to adjust the vehicle audio settings by applying personalized and adaptive audio content and volume, individually controlling the one or more of the vehicle speakers for playback to create precise imaging for object audio using meta-data, adjusting gain for noise compliance, turning on or off commentary in a selected language, and/or adjusting the volume of crowd noise.

4. The audio rendering system of claim 1, wherein the optimal audio settings are based on mood information of an occupant of the vehicle.

5. The audio rendering system of claim 1, wherein the optimal audio settings are determined using one or more of a contextual multi-armed bandit (MAB), epsilon-Greedy, Upper Confidence Bound (UCB), meta-learning, Regularized Linear Bandit, or meta-learning Linear UCB learning strategies.

6. The audio rendering system of claim 1, wherein the vehicle location includes one or more of Global Positioning System (GPS) location, route information, or places-of-interest in a vicinity of the vehicle.

7. A vehicle incorporating the audio rendering system of claim 1.

8. An audio rendering system for a vehicle, the audio rendering system comprising:
a vehicle microphone configured to capture one or more sounds;
a vehicle processor configured to store vehicle data including one or more of vehicle location, vehicle event data, and microphone data and configured to:
determine if noise-reducing action is required based on the vehicle location and the microphone data;
determine an optimal vehicle mode based on the vehicle event data and the vehicle location; and
activate the optimal vehicle mode of the vehicle.

9. The audio rendering system of claim 8, wherein the microphone data includes any sound captured by the vehicle microphone.

10. The audio rendering system of claim 8, wherein the optimal vehicle mode is determined using one or more of a contextual multi-armed bandit (MAB), epsilon-Greedy, Upper Confidence Bound (UCB), meta-learning, Regularized Linear Bandit, or meta-learning Linear UCB learning strategies.

11. The audio rendering system of claim 8, wherein the vehicle location includes one or more of GPS location, route information, or places-of-interest in a vicinity of the vehicle.

12. The audio rendering system of claim 8, wherein the vehicle processor is configured to use third-party information to determine if the noise-reducing action is required.

13. A vehicle incorporating the audio rendering system of claim 8.

14. An audio rendering system for a vehicle, the audio rendering system comprising:
a vehicle microphone configured to capture one or more sounds;
a vehicle processor configured to store vehicle data including one or more of vehicle location, vehicle event data, and microphone data, the vehicle processor configured to:
determine if a noise-reducing action should be implemented based on one or more of the vehicle location and the microphone data;
reduce a noise level within the vehicle based on the microphone data and the vehicle event data; and
return the noise level back to the original noise level once the vehicle processor determines that the noise-reducing action should no longer be implemented based on one or more of the vehicle location and the microphone data.

15. The audio rendering system of claim 14, wherein the noise-reducing action includes adjusting one or more of vehicle mode or vehicle audio settings.

16. The audio rendering system of claim 14, wherein the microphone data includes any sound captured by the vehicle microphone.

17. The audio rendering system of claim 14, wherein the vehicle processor is configured to determine if a noise-reducing action should be implemented using one or more of a contextual multi-armed bandit (MAB), epsilon-Greedy, Upper Confidence Bound (UCB), meta-learning, Regularized Linear Bandit, or meta-learning Linear UCB learning strategies.

18. The audio rendering system of claim 14, wherein the vehicle location includes one or more of GPS location, route information, or places-of-interest in a vicinity of the vehicle.

19. The audio rendering system of claim 14, wherein the vehicle event data includes one or more of user settings, vehicle settings, and passenger information.

20. A vehicle incorporating the audio rendering system of claim 14.
